(19) United States
(12) Patent Application Publication
(10) Pub. No.: US 2002/0013488 A1
(43) Pub. Date: Jan. 31, 2002

(54) High purity sterically hindered diaryl chlorophosphates and method for their preparation

(75) Inventors: John Robert Campbell, Clifton Park, NY (US); Paul Edward Howson, Latham, NY (US); Matthew Ladd Reitz, Clifton Park, NY (US)

Correspondence Address: GENERAL ELECTRIC COMPANY, CRD PATENT DOCKET ROOM 4A59, P O BOX 8, BUILDING K 1 SALAMONE, SCHENECTADY, NY, 12301, US

(73) Assignee: General Electric Company

(21) Appl. No.: 09/934,933

(22) Filed: Aug. 22, 2001

Related U.S. Application Data
(63) Continuation-in-part of application No. 09/537,035, filed on Mar. 28, 2000.
(60) Provisional application No. 60/135,755, filed on May 25, 1999.

(51) Int. Cl. C07F 9/145

(52) U.S. Cl. 558/92

(57) ABSTRACT

High purity sterically hindered diaryl chlorophosphates, having a purity of at least 98% by weight and a proportion of the corresponding aryl dichlorophosphate less than 1.5% by weight, are prepared by a method including the steps of gradually introducing POCl₃ into a mixture of a sterically hindered hydroxyaromatic compound such as 2,6-xylenol and a catalyst such as magnesium chloride, and gradually increasing the temperature of the reaction mixture to a final level in the range of about 135-150° C. The products are capable of reaction with amines such as piperazine to produce sterically hindered phosphoramidates.

### CROSS-REFERENCE TO RELATED APPLICATIONS

This application is a continuation-in-part of copending U.S. application Ser. No. 09/537,035, filed Mar. 28, 2000, which claims the benefit of U.S. Provisional Application No. 60/135,755, filed May 25, 1999, and which applications are incorporated herein by reference.

### BACKGROUND OF THE INVENTION

This invention relates to sterically hindered diaryl chlorophosphates. More particularly, it relates to methods for their preparation in high purity.

Sterically hindered diaryl chlorophosphates such as di-(2,6-xylyl) chlorophosphate (hereinafter sometimes “DXC”), of the formula I:

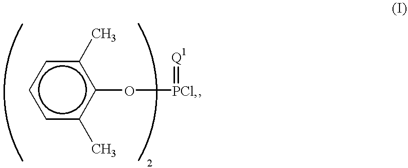

are useful intermediates for the preparation of sterically hindered phosphoramidates such as N,N′-bis[di-(2,6-xylenoxy)phosphinyl]piperazine, hereinafter sometimes “XPP”. The latter are useful as flame retardant additives for synthetic resins, especially thermoplastic resins such as polycarbonates, ABS resins and blends thereof. The use of such sterically hindered phosphoramidates has been discovered to have particular advantages including improved high temperature stability of the resulting compositions. Reference is made, for example, to commonly owned U.S. Pat. Nos. 5,973,041 and 6,221,939.

A method for preparation of sterically hindered phosphoramidates is disclosed in Talley, J. Chem. Eng. Data, 33, 221-222 (1983); it involves the reaction of DXC with an amine such as piperazine in the presence of an acid acceptor such as triethylamine. According to Talley, XPP was obtained in a yield of only 68% which is far below a value sufficient for commercial production. The intermediate DXC was obtained in 90-95% isolated yield by a relatively cumbersome procedure that included a distillation step.

It is of interest, therefore, to maximize the yield of XPP and similar materials and obtain such materials in a state of high purity.

### SUMMARY OF THE INVENTION

The present invention is based on the discovery that impurities in DXC, including trixylyl phosphate and monoxylyl dichlorophosphate, have a significant effect on the yield of such compounds as XPP. A method for producing DXC of high purity has now been developed which minimizes such impurities and allows improved yields of high purity XPP and similar materials without cumbersome processing steps.

In one embodiment the invention is a method for preparing a high purity sterically hindered diaryl chlorophosphate or diaryl chlorothiophosphate which comprises:

(A) gradually introducing, at a temperature below about 120° C. and over a period greater than one hour, the reagent phosphoryl chloride or thiophosphoryl chloride into a mixture of at least one sterically hindered hydroxyaromatic compound reagent and an effective amount of at least one catalyst in the absence of an organic solvent, to form a reaction mixture; and

(B) gradually increasing the temperature of said reaction mixture to a final level in the range of about 135-150° C. over a period of less than about 10 hours; and

(C) analyzing the reaction mixture to determine completeness of reaction, and optionally introducing at least one of hydroxyaromatic compound, phosphoryl chloride or thiophosphoryl chloride at said final temperature level to achieve a final stoichiometric 2:1 molar ratio of hydroxyaromatic compound to phosphoryl chloride or thiophosphoryl chloride.

### DETAILED DESCRIPTION PREFERRED EMBODIMENTS

The high purity sterically hindered diaryl chlorophosphates of this invention include those having the formula II:

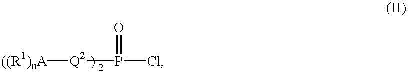

wherein A is an aromatic radical, each R¹ is independently alkyl, aryl or halo, Q¹ is oxygen or sulfur, Q² is oxygen, sulfur, or NR¹, n is from 1 to the number of free valency sites on the aromatic ring(s) and at least one R¹ substituent on an aromatic ring is ortho to the heteroatom-phosphorus linkage. Preferably, A is a phenyl ring, Q¹ and Q² are each oxygen, and n is 1-5. More preferably, each R¹ is C₁₋₄ primary or secondary alkyl, most preferably methyl, Q¹ and Q² are each oxygen, and n is 2 or 3 with two substituents ortho to the O—P linkage.

Preferred high purity sterically hindered diaryl chlorophosphates of this invention include those having the formula III:

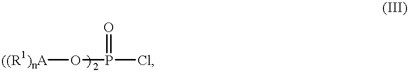

wherein A is an aromatic radical, each R¹ is independently alkyl, aryl or halo, n is from 1 to the number of free valency sites on the aromatic ring(s) and at least one R¹ substituent on an aromatic ring is ortho to the O—P linkage. Preferably, A is a phenyl ring and n is 1-5. More preferably, each R¹ is C₁₋₄ primary or secondary alkyl, most preferably methyl, and n is 2 or 3 with two substituents ortho to the O—P linkage. Particularly preferred chlorophosphates are di-(2,3,6-trimethylphenyl) chlorophosphate, di-(2,4,6-trimethylphenyl) chlorophosphate and di-(2,6-dimethylphenyl) chlorophosphate, also known as di-(2,6-xylyl) chlorophosphate. The most preferred chlorophosphate is DXC.

The sterically hindered diaryl chlorophosphates of the invention are characterized by very high purity, at least 96% and often at least 98% by weight. This is useful for the production of sterically hindered phosphoramidates in high yield. As shown in the examples hereinafter, DXC purity as high as 95% is insufficient to afford phosphoramidate in yields above about 85%.

The diaryl chlorophosphates of the invention are also characterized by low proportions of aryl dichlorophosphate, as illustrated by formula IV:

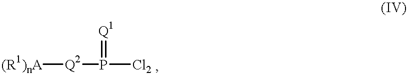

wherein A, R¹, Q¹, and Q², and n are as defined above and at least one R¹ substituent on an aromatic ring is ortho to the heteroatom-phosphorus linkage. The percentage by weight of aryl dichlorophosphate is less than 1.5% and preferably less than 0.5%. Preferably, any aryl dichlorophosphate present has the formula V:

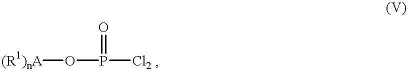

wherein A, R¹, and n are as defined above and at least one R¹ substituent on an aromatic ring is ortho to the O—P linkage. More preferably, A is a phenyl ring and n is 1-5. Most preferably, each R¹ is C₁₋₄ primary or secondary alkyl, most preferably methyl, and n is 2 or 3 with two substituents ortho to the O—P linkage. In particular aryl dichlorophosphates are illustrated by 2,6-xylyl dichlorophosphate (hereinafter sometimes “XDCP”) of the formula VI:

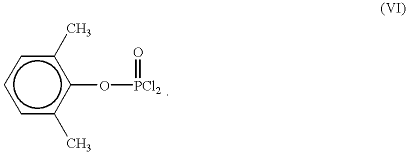

The percentage by weight of XDCP is less than 1.5% and preferably less than 0.5%. Further, the high purity diaryl chlorophosphates of the invention most often contain less than 1% by weight of the corresponding triaryl phosphate, as illustrated by tri-(2,6-xylyl) phosphate (hereinafter sometimes “TXP”) and less than about 2% by weight unreacted hydroxyaromatic compound.

In one embodiment of the present invention a reaction of phosphorus oxychloride (POCl₃; also known as phosphoryl chloride) or thiophosphoryl chloride (PSCl₃) with at least one sterically hindered hydroxyaromatic compound takes place in the presence of an effective amount of at least one catalyst in the absence of organic solvent. In the present context absence of organic solvent means that no solvent is added to the reaction mixture and that the only solvent that may be present is that present as impurities in the chemical reagents used. By effective amount of catalyst is meant an amount which provides diaryl chlorophosphates of the formula II in the desired purity within the process parameters herein specified. Preferably the catalyst is at least one alkaline earth metal halide or aluminum chloride, tin tetrachloride, titanium tetrachloride or zinc chloride. Illustrative alkaline earth metal halides are calcium chloride, magnesium chloride, calcium bromide and barium chloride. Magnesium chloride is preferred.

Sterically hindered hydroxyaromatic compounds may have the formula VII:

(R¹)ₙA—OH (VII),

wherein A, R¹ and n are as previously defined. 2,6-Xylenol (2,6-dimethylphenol) is preferred, and frequent reference will be made to it hereinafter; however, it should be understood that other sterically hindered hydroxyaromatic compounds of formula VII, such as, but not limited to, 2,4,6-trimethylphenol or 2,3,6-trimethylphenol, may be substituted therefor. Mixtures of sterically hindered hydroxyaromatic compounds may also be used.

In various embodiments in step A phosphorus oxychloride is introduced gradually into a mixture of at least one sterically hindered hydroxyaromatic compound and at least one catalyst, preferably at least one alkaline earth metal halide. In one embodiment the sterically hindered hydroxyaromatic compound comprises 2,6-xylenol. The rate of introduction is most often a rate effective to complete POCl₃ addition within about 5 hours, preferably within about 2 hours, and more preferably within about 1.5 hours. Shorter introduction times are best for maximum productivity. Addition is at a temperature below about 120° C., preferably in the range of about 80-120° C. The temperature range is chosen so that hydrogen chloride evolution is kept at a manageable level while allowing the desired reaction to proceed at a convenient rate. When the temperature is higher than about 120° C., then hydrogen chloride evolution may entrain some starting materials such as phosphorus oxychloride leading to an imbalance in stoichiometry and possible formation of undesired materials such as triaryl phosphate. When the temperature is below about 80° C., then the reaction may be undesirably slow leading to unnecessarily long reaction times.

In various embodiments the amount of POCl₃ introduced in step A is generally a stoichiometric amount for the formation of the desired diaryl chlorophosphate. Thus, the molar ratio of POCl₃ to hydroxyaromatic compound is about 0.5:1. It should be understood, however, that the proportions of these reagents will vary according to their purity, with adjustments in proportions being made particularly in response to the fact that commercially available POCl₃ may be only in the range of 90-98% pure and, therefore, more than the calculated amount may be necessary.

In addition to the purity parameter, other factors may influence the proportions of reagents. For example, volatilization of hydroxyaromatic compound during the POCl₃ addition may diminish the amount of POCl₃ required. The combined effects of all of these factors may be determined as the reaction proceeds by art-recognized analysis methods, such as gas chromatography, high performance liquid chromatography, and/or nuclear magnetic resonance spectroscopy, with adjustments in proportions being made accordingly, particularly as a final step as described hereinafter.

The amount of catalyst, preferably alkaline earth metal halide, in the reaction mixture is an effective amount to catalyze the reaction between the POCl₃ and the hydroxyaromatic compound. That will most often be an amount in the range of about 0.01-10 mole percent, preferably about 0.5-8 mole percent and more preferably about 2-5 mole percent based on hydroxyaromatic compound.

In step B, the temperature of the reaction mixture is gradually increased after POCl₃ addition is substantially complete in order to convert all the reactants to the desired final products in minimum time. Typically, the temperature increase is staged so that the reaction is substantially complete within a period of less than about 10 hours, preferably less than about 8 hours. Substantially complete reaction means that no additional increase in the amount of desired product may be detected. For this purpose the temperature increase is typically staged so as to attain a final temperature in the range of about 135-150° C. within a period of less than about 10 hours, preferably less than about 8 hours. Depending upon such factors as the scale of reaction and the starting temperature, the final temperature level may be typically obtained in about 7-8 hours to provide for substantially complete reaction. Shorter reaction times are best for maximum productivity.

If analysis during the course of the process in various embodiments shows that the POCl₃-hydroxyaromatic compound reaction is not complete, as typically evidenced by the presence of one of the reagents at the end of step B, it is within the scope of the invention to perform a subsequent step of (C) introducing further hydroxyaromatic compound, POCl₃ or both at said final temperature level to achieve a final stoichiometric 2:1 molar ratio of said sterically hindered hydroxyaromatic compound to said POCl₃, considering the purity of said reagents. This is done in response to the combination of factors previously noted, so as to optimize the conditions conducive to production of a high yield of diaryl chlorophosphate. Conversely, if analysis during the course of the process in various embodiments shows that the reaction is complete, then introduction of additional reagents need not be done.

Following substantial completion of the reaction, the sterically hindered diaryl chlorophosphates may be isolated in high purity by standard methods well known to those skilled in the art, or used without isolation in a subsequent reaction step. Isolation steps, if used, may include any appropriate process such as one or more steps of filtration, extraction, or distillation. A process comprising one or more filtration steps may be preferred to remove catalyst residues, but for most applications the diaryl chlorophosphate is typically used without isolation.

The high purity sterically hindered diaryl chlorophosphates of this invention may undergo reaction with various diamino compounds to produce sterically hindered phosphoramidates and the like in high yield. Any compound, acyclic or cyclic, containing at least two basic N-H groups may be employed in said reaction. Suitable compounds include those of the formula VIII

R²NH—CH₂CH₂—NHR² (VIII),

wherein each R² is a C₁₋₄ primary or secondary alkyl radical or both R² radicals taken together are ethylene. Illustrative acyclic compounds are N,N′-dimethylethylenediamine and N,N′-diethylethylenediamine. Heterocyclic compounds are generally preferred; they are illustrated by piperazine and 1,2,3,4-tetrahydroquinoxaline, both unsubstituted and substituted. Piperazine is most preferred.

In one preferred embodiment, the diaryl chlorophosphates of this invention may be used to produce a phosphoramidate having a glass transition temperature of at least about 0° C., preferably of at least about 10° C., and most preferably of at least about 20° C. In particular, in one embodiment the diaryl chlorophosphates of the invention may be used to produce a phosphoramidate of the formula IX:

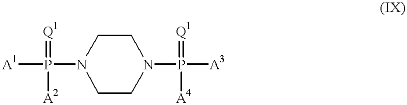

wherein each Q¹ is independently oxygen or sulfur; and each of A¹⁻⁴ is independently an alkoxy, alkylthio, aryloxy, or arylthio residue, or an aryloxy or arylthio residue containing at least one alkyl or halogen substitution, or mixture thereof; or an amine residue. In one embodiment each Q¹ is oxygen, and each A¹⁻⁴ is an aryloxy moiety with at least one aryloxy moiety having at least one substituent on an aromatic ring ortho to the oxygen linkage. In another embodiment each Q¹, is oxygen, and each A¹⁻⁴ moiety is independently an aryloxy moiety with at least one substituent on each aromatic ring ortho to the oxygen linkage, optionally further substituted. In still another embodiment each Q¹ is oxygen, and each A¹⁻⁴ moiety is independently an aryloxy moiety with at least two substituents on each aromatic ring ortho to the oxygen linkage, as for example a 2,6-disubstituted phenoxy moiety, optionally further substituted. In various embodiments substituents may be C₁₋₈ straight-chain or branched alkyl, or halogen. In still another embodiment of the invention, each Q¹ is oxygen, and each A¹⁻⁴ moiety is independently phenoxy, 2,6-dimethylphenoxy, 2,3,6-trimethylphenoxy, or 2,4,6-trimethylphenoxy. In yet still another embodiment of the invention, each Q¹ is oxygen, and all A¹⁻⁴ moieties are phenoxy, 2,6-dimethylphenoxy, 2,3,6-trimethylphenoxy, or 2,4,6-trimethylphenoxy. These phosphoramides are piperazine-type phosphoramides. In the above formula wherein each Q¹ is oxygen, and each A¹⁻⁴ moiety is a 2,6-dimethylphenoxy moiety, the glass transition temperature of the phosphoramidate is about 62° C. and the melting point is about 192° C.

In another preferred embodiment, the diaryl chlorophosphates of this invention may be used to produce a phosphoramidate having a glass transition temperature of at least about 0° C., preferably of at least about 10° C., and most preferably of at least about 20° C., of the formula X:

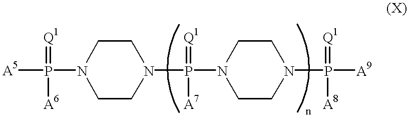

wherein each Q¹ is independently oxygen or sulfur; and each of A⁵⁻⁹ is independently an alkyloxy, alkylthio, aryloxy, or arylthio residue, or an aryloxy or arylthio residue optionally containing at least one alkyl or halogen substitution, or mixture thereof; or an amine residue; and n is from 0 to about 200. In one embodiment each Q¹ is oxygen, and each A⁵⁻⁹ moiety is independently phenoxy or a substituted phenoxy moiety. In another embodiment each Q¹ is oxygen, and each A⁵⁻⁹ is an aryloxy moiety with at least one aryloxy moiety having at least one substituent on an aromatic ring ortho to the oxygen linkage. In a still another embodiment each Q¹ is oxygen, and each A⁵⁻⁹ moiety is independently an aryloxy moiety with at least one substituent on each aromatic ring ortho to the oxygen linkage, optionally further substituted. In a still another embodiment each Q¹ is oxygen, and each A⁵⁻⁹ moiety is independently an aryloxy moiety with at least two substituents on each aromatic ring ortho to the oxygen linkage, as for example a 2,6-disubstituted phenoxy moiety, optionally further substituted. In various embodiments substituents are C₁₋₈ straight-chain or branched alkyl, or halogen. In one embodiment of the invention, each Q¹ is oxygen, and each A⁵⁻⁹ moiety is independently phenoxy, 2-methylphenoxy, 2,6-dimethylphenoxy, 2,3,6-trimethylphenoxy, or 2,4,6-trimethylphenoxy, and n is from 0 to about 5. In another embodiment of the invention, each Q¹ is oxygen, and all A⁵⁻⁹ moieties are phenoxy, 2-methylphenoxy, 2,6-dimethylphenoxy, 2,3,6-trimethylphenoxy, or 2,4,6-trimethylphenoxy, and n is from 0 to about 5.

In another embodiment the diaryl chlorophosphates of this invention may be used to produce a phosphoramidate having a glass transition temperature of at least about 0° C., preferably of at least about 10° C., and most preferably of at least about 20° C., of the formula XI:

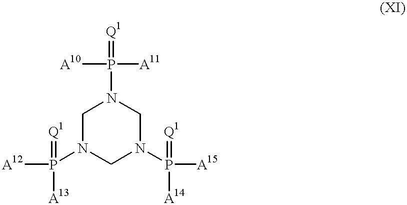

wherein each Q¹ is independently oxygen or sulfur; and each of A¹⁰⁻¹⁵ is independently an alkyloxy, alkylthio, aryloxy, or arylthio residue, or an aryloxy or arylthio residue optionally containing at least one alkyl or halogen substitution, or mixture thereof; or an amine residue. In one embodiment each Q¹ is oxygen, and each A¹⁰⁻¹⁵ moiety is independently phenoxy or a substituted phenoxy moiety. In another embodiment each Q¹ is oxygen, and each A¹⁰⁻¹⁵ is an aryloxy moiety with at least one aryloxy moiety having at least one substituent on an aromatic ring ortho to the oxygen linkage. In a still another embodiment each Q¹ is oxygen, and each A¹⁰⁻¹⁵ moiety is independently an aryloxy moiety with at least one substituent on each aromatic ring ortho to the oxygen linkage, optionally further substituted. In yet still another embodiment each Q¹ is oxygen, and each A¹⁰⁻¹⁵ moiety is independently an aryloxy moiety with at least two substituents on each aromatic ring ortho to the oxygen linkage, as for example a 2,6-disubstituted phenoxy moiety, optionally further substituted. In various embodiments substituents are C₁₋₈ straight-chain or branched alkyl, or halogen. In one embodiment of the invention, each Q¹ is oxygen, and each A¹⁰⁻¹⁵ moiety is independently phenoxy, 2-methylphenoxy, 2,6-dimethylphenoxy, 2,3,6-trimethylphenoxy, or 2,4,6-trimethylphenoxy. In another embodiment of the invention, each Q¹ is oxygen, and all A¹⁰⁻¹⁵ moieties are 2-methylphenoxy, 2,6-dimethylphenoxy, 2,3,6-trimethylphenoxy, or 2,4,6-trimethylphenoxy.

In another embodiment the diaryl chlorophosphates of this invention may be used to produce a phosphoramidate having a glass transition temperature of at least about 0° C., preferably of at least about 10° C., and most preferably of at least about 20° C., of the formula XII:

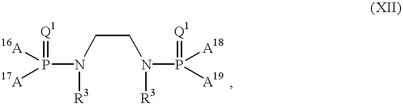

wherein each Q¹ is independently oxygen or sulfur; each of A¹⁶⁻¹⁹ is independently an alkyloxy, alkylthio, aryloxy, or arylthio residue, or an aryloxy or arylthio residue optionally containing at least one alkyl or halogen substitution, or mixture thereof; or an amine residue; and each R³ is an alkyl radical, or both R³ radicals taken together are an alkylidene or alkyl-substituted alkylidene radical. In various embodiments each Q¹ is oxygen, and each A¹⁶⁻¹⁹ moiety is independently phenoxy or a substituted phenoxy moiety. In another embodiment each Q¹ is oxygen, and each A¹⁶⁻¹⁹ is an aryloxy moiety with at least one aryloxy moiety having at least one substituent on an aromatic ring ortho to the oxygen linkage. In still other embodiments each Q¹ is oxygen, and each A¹⁶⁻¹⁹ moiety is independently an aryloxy moiety with at least one substituent on each aromatic ring ortho to the oxygen linkage, optionally further substituted. In yet still other embodiments each Q¹ is oxygen, and ¹⁶⁻¹⁹ each A¹⁶⁻¹⁹ moiety is independently an aryloxy moiety with at least two substituents on each aromatic ring ortho to the oxygen linkage, as for example a 2,6-disubstituted phenoxy moiety, optionally further substituted. In various embodiments substituents are C₁₋₈ straight-chain or branched alkyl, or halogen. In various embodiments of the invention, each Q¹ is oxygen, and each A¹⁶⁻¹⁹ moiety is independently phenoxy, 2-methylphenoxy, 2,6-dimethylphenoxy, 2,3,6-trimethylphenoxy, or 2,4,6-trimethylphenoxy. In one embodiment, each Q¹ is oxygen; both R³ radicals taken together are an unsubstituted (CH₂)ₘ alkylidene radical, wherein m is 2 to 10; and each A¹⁶⁻¹⁹ moiety is independently an aryloxy moiety with at least one substituent on each aromatic ring ortho to the oxygen linkage, optionally further substituted, especially 2-methylphenoxy, 2,6-dimethylphenoxy, 2,3,6-trimethylphenoxy, or 2,4,6-trimethylphenoxy. In another embodiment, each Q¹ is oxygen; each R³ is methyl; and each A¹⁶⁻¹⁹ moiety is independently an aryloxy moiety with at least one substituent on each aromatic ring ortho to the oxygen linkage, optionally further substituted, especially 2-methylphenoxy, 2,6-dimethylphenoxy, 2,3,6-trimethylphenoxy, or 2,4,6-trimethylphenoxy.

In yet another embodiment the diaryl chlorophosphates of this invention may be used to produce a phosphoramidate having a glass transition point of at least about 0° C., preferably of at least about 10° C., and most preferably of at least about 20° C., of the formula XIII:

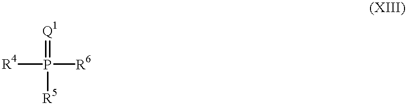

wherein Q¹ is oxygen or sulfur, and R⁴ is of the formula XIV:

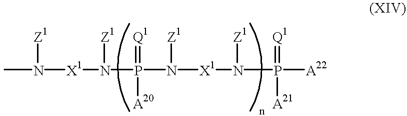

wherein each Q¹ is independently oxygen or sulfur; each of A²⁰⁻²² is independently an alkyloxy, alkylthio, aryloxy, or arylthio residue, or an aryloxy or arylthio residue optionally containing at least one alkyl or halogen substitution, or mixture thereof; or an amine residue; each Z¹ is an alkyl radical, aromatic radical, or aromatic radical containing at least one alkyl or halogen substitution or mixture thereof; each X¹ is an alkylidene radical, aromatic radical, or aromatic radical containing at least one alkyl or halogen substitution or mixture thereof; n is from 0 to about 200; and R⁵ and R⁶ are each independently an alkyloxy, alkylthio, aryloxy, or arylthio residue, or an aryloxy or arylthio residue optionally containing at least one alkyl or halogen substitution, or mixture thereof; or an amine residue. In various embodiments each Q¹ is oxygen, and each A²⁰⁻²² moiety and each R⁵⁻⁶ moiety is independently phenoxy or a substituted phenoxy moiety. In other embodiments each Q¹ is oxygen, and each A²⁰⁻²² moiety and each R⁵⁻⁶ moiety is independently an aryloxy moiety with at least one aryloxy moiety having at least one substituent on an aromatic ring ortho to the oxygen linkage, optionally further substituted. In still other embodiments each Q¹ is oxygen, and each A²⁰⁻²² moiety and each R⁵⁻⁶ moiety is independently an aryloxy moiety with at least one substituent on each aromatic ring ortho to the oxygen linkage, optionally further substituted. In yet still other embodiments each Q¹ s oxygen, and each A²⁰⁻²² moiety and each R⁵⁻⁶ moiety is independently an aryloxy moiety with at least two substituents on each aromatic ring ortho to the oxygen linkage, as for example a 2,6-disubstituted phenoxy moiety, optionally further substituted. In various embodiments substituents are C₁₋₈ straight-chain or branched alkyl, or halogen. In one embodiment, each Q¹ is oxygen; each A²⁰⁻²² moiety is independently phenoxy, 2-methylphenoxy, 2,6-dimethylphenoxy, 2,3,6-trimethylphenoxy, or 2,4,6-trimethylphenoxy; each Z¹ is methyl or benzyl; each X¹ is an alkylidene radical containing 2-24 carbon atoms; n is from 0 to about 5; and R⁵ and R⁶ are each independently phenoxy, 2-methylphenoxy, 2,6-dimethylphenoxy, 2,3,6-trimethylphenoxy, or 2,4,6-trimethylphenoxy.

In still another embodiment the diaryl chlorophosphates of this invention may be used to produce a phosphoramidate having a glass transition point of at least about 0° C., preferably of at least about 10° C., and most preferably of at least about 20° C., of the formula XV:

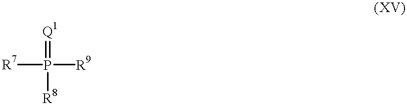

wherein Q¹ is oxygen or sulfur; and R⁷ is of the formula XVI:

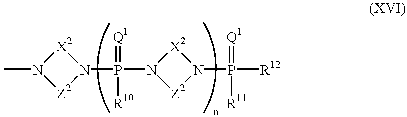

wherein each Q¹ is independently oxygen or sulfur; each X² is an alkylidene or alkyl-substituted alkylidene residue, aryl residue, or alkaryl residue; each Z² is an alkylidene or alkyl-substituted alkylidene residue; each of R¹⁰, R¹¹, and R¹² is independently an alkyloxy, alkylthio, aryloxy, or arylthio residue, or an aryloxy or arylthio residue optionally containing at least one alkyl or halogen substitution, or mixture thereof; or an amine residue; n is from 0 to about 5; and R⁸ and R⁹ are each independently an alkyloxy, alkylthio, aryloxy, or arylthio residue, or an aryloxy or arylthio residue optionally containing at least one alkyl or halogen substitution, or mixture thereof; or an amine residue. In various embodiments each Q¹ is oxygen, and each R¹⁰⁻¹² moiety and each R⁸⁻⁹ moiety is independently phenoxy or a substituted phenoxy moiety. In other embodiments each Q¹ is oxygen, and each R¹⁰⁻¹² moiety and each R⁸⁻⁹ moiety is independently an aryloxy moiety with at least one aryloxy moiety having at least one substituent on an aromatic ring ortho to the oxygen linkage, optionally further substituted. In still other embodiments each Q¹ is oxygen, and each R¹⁰⁻¹² moiety and each R⁸⁻⁹ moiety is independently an aryloxy moiety with at least one substituent on each aromatic ring ortho to the oxygen linkage, optionally further substituted. In yet still other embodiments each Q¹ is oxygen, and each R¹⁰⁻¹² moiety and each R⁸⁻⁹ moiety is independently an aryloxy moiety with at least two substituents on each aromatic ring ortho to the oxygen linkage, as for example a 2,6-disubstituted phenoxy moiety, optionally further substituted. In various embodiments substituents are C₁₋₈ straight-chain or branched alkyl, or halogen. In one embodiment, each Q¹ is oxygen; each X² is an alkylidene or alkyl-substituted alkylidene residue; each Z² is an alkylidene or alkyl-substituted alkylidene residue; each of R⁸, R⁹, R¹⁰, R¹¹, and R¹² is independently phenoxy, 2-methylphenoxy, 2,6-dimethylphenoxy, 2,3,6-trimethylphenoxy, or 2,4,6-trimethylphenoxy; and n is from 0 to about 5. In another embodiment, each Q¹ is oxygen; each X² and Z² is independently an unsubstituted alkylidene residue of the form (CH₂)ₘ, wherein m is 2 to 10; each of R⁸, R⁹, R¹⁰, R¹¹, and R¹² is independently phenoxy, 2-methylphenoxy, 2,6-dimethylphenoxy, 2,3,6-trimethylphenoxy, or 2,4,6-trimethylphenoxy; and n is from 0 to about 5. In other embodiments, the phosphoramide is derived from piperazine (i.e. X² and Z² are each —CH₂—CH₂—).

In another preferred embodiment, the diaryl chlorophosphates of this invention may be used to produce a cyclic phosphoramidate having a glass transition point of at least about 0° C., preferably of at least about 10° C., and most preferably of at least about 20° C. of the formula XVII:

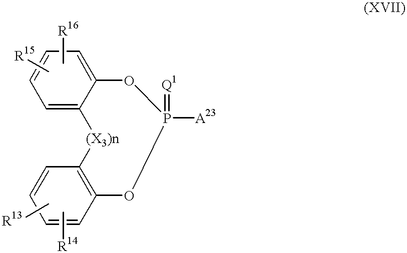

wherein each of R¹³⁻¹⁶ is independently a hydrogen, an alkyl radical, or halogen, X³ is an alkylidene radical, Q¹ is oxygen or sulfur, and A²³ is a group derived from a primary or secondary amine having the same or different radicals that can be aliphatic, alicyclic, aromatic, or alkaryl, or A is a group derived from a heterocyclic amine, or A²³ is a hydrazine compound. In one embodiment Q¹ is oxygen. In other embodiments each Q¹ is oxygen, and each of the two phenyl rings is independently at least a monosubstituted phenoxy moiety, wherein the at least one substituent is represented by the linkage to X³. In still other embodiments each Q¹ is oxygen, and each of the two phenyl rings is independently at least disubstituted wherein at least one substituent is represented by the linkage to X³. In various embodiments substituents R¹³⁻¹⁶, when present, are straight-chain or branched alkyl or halogen. In another embodiment R¹³⁻¹⁶ substituents on each aromatic ring are each 2,4-dimethyl or 2,3-dimethyl groups relative to the oxygen linkage. In another embodiment R¹³ and R¹⁵ are each methyl ortho to the oxygen linkage, and R¹⁴ and R¹⁶ are each hydrogen. In a still another embodiment R¹³⁻¹⁶ are hydrogen. It should be noted that when n is 0, then the two aryl rings are linked together at that site (i.e. where X³ is absent) by a single bond in the positions ortho,ortho′ to the phosphoryl bonds.

In still another preferred embodiment, the diaryl chlorophosphates of this invention may be used to produce a bis(cyclic) phosphoramidate having a glass transition point of at least about 0° C., preferably of at least about 10° C., and most preferably of at least about 20° C. of the formula XVIII:

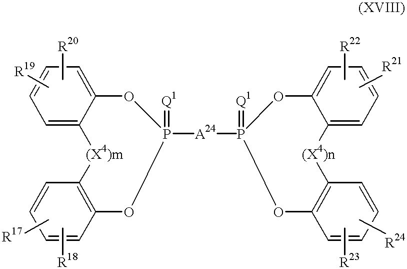

wherein Q¹ is oxygen or sulfur; each of R¹⁷⁻²⁴ is independently a hydrogen or an alkyl radical; X⁴ is an alkylidene radical; m and n are each independently 0 or 1; and A²⁴ is

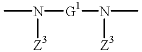

wherein G¹ is sulfur, an alkylidene radical, alkyl-substituted alkylidene radical, aryl radical, or alkaryl radical, and each Z³ is independently an alkyl radical, an aryl radical, or an aryl radical containing at least one alkyl or halogen substitution, or mixture thereof; or wherein A²⁴ is

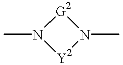

wherein G² is alkylidene, aryl, or alkaryl, and Y² is alkylidene or alkyl-substituted alkylidene. In various embodiments each Q¹ is oxygen, and each of the four phenyl rings is independently at least a monosubstituted phenoxy moiety,

wherein the at least one substituent is represented by the linkage to X⁴. In still other embodiments each Q¹ is oxygen, and each of the two phenyl rings is independently at least disubstituted wherein at least one substituent is represented by the linkage to X⁴. In various embodiments substituents R¹⁷⁻²⁴, when present, are straight-chain or branched alkyl, or halogen. In one embodiment R¹⁷⁻²⁴ substituents on each aromatic ring are each 2,4-dimethyl or 2,3-dimethyl groups relative to the oxygen linkage. In another embodiment R¹⁷, R¹⁹, R²¹, and R²³ are each methyl ortho to the oxygen linkage, and R¹⁸, R²⁰, R²², and R²⁴ are each hydrogen. In a still another embodiment R¹⁷⁻²⁴ are hydrogen. In various embodiments phosphoramides include those wherein Q¹ is oxygen; A²⁴ is a residue of piperazine; the phosphoramide has a plane of symmetry through A²⁴; R¹⁷⁻²⁴ are hydrogen; n and m are each 1; and X⁴ is CHR²⁵ wherein R²⁵ is a hydrogen or an alkyl residue of from about 1 to about 6 carbon atoms. It should be noted that when either or both of m or n is 0, then the two aryl rings are linked together at that site (i.e. where X⁴ is absent) by a single bond in the positions ortho,ortho′ to the phosphoryl bonds.

The diaryl chlorophosphates of this invention may also be used to make phosphoramidates with intermediate glass transition temperatures by providing a mixture of various substituted and non-substituted aryl moieties within the phosphoramidate.

The invention is illustrated by the following examples. All parts are by weight. Reaction mixtures were typically analyzed by gas chromatography with area percent of volatile constituents corrected for their relative responses.

### EXAMPLE 1

A 250-milliliter (ml) round-bottomed flask fitted with a stirrer, condenser, nitrogen purge means and thermometer was charged with 75 grams (g) (614 millimoles [mmol]) of dry 2,6-xylenol and 2.25 g (23.6 mmol) of magnesium chloride. The flask was heated to 110° C. in a nitrogen atmosphere and 51.5 g (336 mmol) of POCl₃, was added over 1.5 hours, with stirring. Heating at 110° C. was continued for an additional 1.5 hours, after which the temperature was increased to 141° C. over 5 hours (total 8 hours). After 7 hours, the reaction mixture was analyzed and an additional 5 g of xylenol (total 655 mmol) was added; after 8 hours, the reaction mixture was analyzed and 600 milligrams (mg) additional (total 340 mmol) POCl₃ was introduced and, after about 1 hour, the reaction was shown by gas chromatography to be complete. The product was determined by analysis to be 98.3% pure DXC, with 0.2% XDCP, 0.7% TXP and 0.8% unreacted 2,6-xylenol being present.

### EXAMPLE 2

A 380-liter glass-lined Pfaudler reactor was flushed with nitrogen, warmed to 60° C. and charged with 69.3 kilograms (kg) (567.3 moles) of 2,6-xylenol and 2.075 kg (21.8 moles) of magnesium chloride. A caustic scrubber was attached to the reactor and 45 kg (293.5 moles) of POCl₃ was introduced over 90 minutes from a nitrogen-pressurized stainless steel vessel, as the temperature of the mixture rose to 72° C.

Over the next 10.5 hours, the temperature was gradually raised to 139° C. Analysis showed the reaction to be 95% complete. An additional 500 ml of POCl₃ was introduced at 111° C. and the temperature was again gradually raised to 139° C. over 7 hours. Further analysis showed the reaction to be more than 98% complete.

The reaction mixture was cooled to 120° C. and purged with nitrogen through a subsurface tube. It was then further cooled to 59° C. and 150 kg of methylene chloride was added, with still further cooling to 40° C. The resulting solution was filtered, yielding a solution of DXC shown by analysis to be more than 98% pure.

### CONTROL EXAMPLES 1-3

In these control examples employing the reaction system of Example 1, DXC samples (25 g, 77 mmol) of various degrees of purity were dissolved in 25 ml of methylene chloride and 9.15 g of triethylamine was added. Dry piperazine, 3.32 g (106 mmol) was added in two portions, 30 minutes apart, and the mixture was heated under reflux with periodic sampling until the reaction was complete. Analysis of the controlled samples was performed for XPP and also for oligomers formed by the reaction of XDCP with piperazine.

The results are given in the following table. DXC samples were as follows:

| Run | Control Example 1 | | Control Example 2 | | Control Example 3 | |
|---|---|---|---|---|---|---|
| Time, | | Oligomers | | Oligomers | | Oligomers |
| hrs | XPP, % | % | XPP, % | % | XPP, % | % |
| 0.5 | 50.8 | 4.9 | 58.4 | 11.0 | — | — |
| 1 | 79.5 | 9.6 | 69.0 | 13.9 | 81.7 | 4.7 |
| 2 | 84.2 | 10.4 | 71.4 | 15.6 | 85.3 | 5.3 |
| 3 | 84.8 | 10.7 | 71.7 | 15.9 | 85.5 | 5.3 |
| 4 | 85.1 | 10.8 | 71.6 | 16.4 | 86.7 | 5.6 |
| 5 | 85.1 | 10.8 | 71.5 | 16.5 | 87.5 | 5.5 |

Control Example 1-95% DXC, 5% XDCP;
Control Example 2-92% DXC, 8% XDCP;
Control Example 3-93% DXC, 5% XDCP, 2% 2,6-xylenol.

As shown in Control Examples 1 and 2, DXC purity levels of 95% and 92% and XDCP levels of 5% or greater lead to significantly lower yields of XPP in comparison with the high purity DXC products of Examples 1 and 2. Control Example 3 shows that the addition of 2,6-xylenol to compensate for high XDCP levels does not significantly improve XPP yield. Thus, the effectiveness of the invention to improve XPP yields is demonstrated.

While typical embodiments have been set forth for the purpose of illustration, the foregoing descriptions and examples should not be deemed to be a limitation on the scope of the invention. Accordingly, various modifications, adaptations, and alternatives may occur to one skilled in the art without departing from the spirit and scope of the present invention.

1. A method for preparing a high purity sterically hindered diaryl chlorophosphate or diaryl chlorothiophosphate which comprises:
(A) gradually introducing, at a temperature below about 120° C. and over a period greater than one hour, the reagent phosphoryl chloride or thiophosphoryl chloride into a mixture of at least one sterically hindered hydroxyaromatic compound and an effective amount of at least one catalyst in the absence of an organic solvent, to form a reaction mixture; and
(B) gradually increasing the temperature of said reaction mixture to a final level in the range of about 135-150° C. over a period of less than about 10 hours; and
(C) analyzing the reaction mixture to determine completeness of reaction, and optionally introducing at least one of hydroxyaromatic compound, phosphoryl chloride or thiophosphoryl chloride at said final temperature level to achieve a final stoichiometric 2:1 molar ratio of hydroxyaromatic compound to phosphoryl chloride or thiophosphoryl chloride.

2. A method according to claim 1 wherein the diaryl chlorophosphate or diaryl chlorothiophosphate has the formula 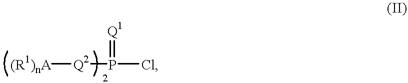
wherein A is an aromatic radical, each R¹ is independently alkyl, aryl or halo, Q¹ is oxygen or sulfur, Q² is oxygen, n is from 1 to the number of free valency sites on the aromatic rings and at least one R¹ substituent on an aromatic ring is ortho to the heteroatom-phosphorus linkage.

3. A method according to claim 1 wherein the at least one catalyst is an alkaline earth metal halide.

4. A method according to claim 3 wherein the amount of alkaline earth metal halide is in the range of about 2-5 mole percent based on total hydroxyaromatic compound.

5. A method according to claim 3 wherein the alkaline earth metal halide is magnesium chloride.

6. A method according to claim 1 wherein the temperature in step A is in the range of about 80-120° C.

7. A method according to claim 1 wherein the time period in step B is in the range of about 7-8 hours.

8. A method according to claim 1 wherein the hydroxyaromatic compound comprises 2,6-xylenol.

9. A method according to claim 1 wherein the molar ratio of phosphorus oxychloride to hydroxyaromatic compound is about 0.5:1.

10. The method of claim 1 in which the diaryl chlorophosphate or diaryl chlorothiophosphate is used without isolation in a subsequent reaction.

11. The method of claim 1 in which the diaryl chlorophosphate or diaryl chlorothiophosphate is isolated before use in a subsequent reaction.

12. A method for preparing high purity di-(2,6-xylyl) chlorophosphate or chlorothiophosphate which comprises:
(A) gradually introducing, at a temperature below about 120° C. and over a period greater than one hour, the reagent phosphoryl chloride or thiophosphoryl chloride into a mixture of 2,6-xylenol and an effective amount of magnesium chloride catalyst in the absence of an organic solvent to form a reaction mixture;
(B) gradually increasing the temperature of said reaction mixture to a final level in the range of about 135-150° C. over a period of about 7-8 hours; and
(C) analyzing the reaction mixture to determine completeness of reaction, and optionally introducing at least one of 2,6-xylenol, phosphoryl chloride or thiophosphoryl chloride at said final temperature level to achieve a final stoichiometric 2:1 molar ratio of 2,6-xylenol to phosphoryl chloride or thiophosphoryl chloride.

13. The method of claim 12 in which the di-(2,6-xylyl) chlorophosphate is used without isolation in a subsequent reaction.

14. The method of claim 12 in which the di-(2,6-xylyl) chlorophosphate is isolated before use in a subsequent reaction.
